(19) United States
(12) Patent Application Publication
(10) Pub. No.: US 2015/0307292 A1
(43) Pub. Date: Oct. 29, 2015

(54) SLIDING DEVICE FOR A PALLETIZING DEVICE

(71) Applicant: Windmöller & Hölscher KG, Lengerich (DE)

(72) Inventors: Ralf AHLERS, Lengerich (DE); Jürgen STEINBERG, Horstel (DE); Martin KÖLKER, Ibbenburen (DE)

(21) Appl. No.: 14/696,489

(22) Filed: Apr. 27, 2015

(30) Foreign Application Priority Data
Apr. 28, 2014 (DE) 10 2014 105 930.1

(51) Int. Cl. B65G 57/14

(52) U.S. Cl. CPC B65G 57/14

(57) ABSTRACT

The invention relates to a sliding device for a palletizing device for stacking of filled sacks to a sack stacking, comprising a sliding area and a sliding table assembled beneath the sliding area and a slider for sliding of the sacks from the sliding area to the sliding table, wherein the sliding area comprises at least a structure section with a three dimensional surface structure for the reduction of the friction during sliding of the sacks.

### RELATED APPLICATION

This application claims the benefit of priority of German Patent Application No. 10 2014 105 930.1 filed Apr. 28, 2014, the contents of which are incorporated herein by reference in their entirety.

### BACKGROUND OF THE INVENTION

The present invention relates to a sliding device for a palletizing device for stacking of filled sacks to a sack stacking.

It is basically known that palletizing devices are used in order to stack single filled sacks to a sack stacking. This serves for a better transportability and an increased storage capability of the filled sacks. Herefore usually single layers are configured which can comprise two or more rows of filled sacks. The single layers are layered on top of one another in order to configure a sack stacking.

For the performance of the particular layer normally a sliding device is intended in the palletizing device. The sliding device comprises a sliding area and a sliding table wherein on the sliding area the layers are configured. After the performance of the particular layer a movement of this layer occurs from the sliding area to the neighbouring sliding table using a slider. This movement is normally transverse to the conveyance movement and the filled sacks from a separate supplying device. Thus normally a lateral conveyance of the filled sacks occurs and a straight sliding of the layer of the filled sacks on the sliding table.

It is a disadvantage with the known device that for the movement of the layer using the slider on the sliding table a high friction force has to be overcome. Thus, the filled sacks comprise a great contact area with the sliding area so that a high friction area with a corresponding normally high weight of the filled sacks leads to a high resistance force from friction. This can lead to a high abrasion and even to a damage of the filled sacks during the sliding process. Known solutions like for example an anti-stick coating or a complex air cushion are not able to completely remedy the disadvantages. Thus, anti-stick coatings are only temporally usable since due to the high friction they also are subject to a great abrasion. The performance of an active air cushion however is affiliated to a very high constructive effort so that here neither the space nor the costs are taken to account in a sufficient manner.

### SUMMARY OF THE INVENTION

It is the object of the present invention to at least partially avoid the previously described disadvantages. Particularly, it is the object of the present invention to facilitate the sliding process between the sliding table and the sliding area in a cost-efficient and simple manner.

The previous object is solved by a sliding device with the features of claim 1. Further features and details of the invention result from the depending claims, the description and the drawings. Thereby the features and details which are described corresponding to the sliding device according to claim 1 also apply correspondingly with the sliding device according to the dependent claims and vice versa, so that according to the disclosure and the single aspects of the invention, it can always be reciprocally related to.

A sliding device according to the invention for a palletizing device for stacking of filled sacks to a sack stacking comprises a sliding area. Beneath the sliding area a sliding table is assembled. Further a slider is intended for sliding the sacks from the sliding area to the sliding table. The sliding device according to the invention is wherein the sliding area comprises at least a structural section with a three dimensional surface structure for reducing the friction during the sliding of the sacks.

A sliding device according to the invention generally bases on known sliding devices.

Particularly, here the distribution in a sliding area on which the respective layer from single filled sacks or the rows of sacks is configured and a sliding table which is subsequently relevant for the stacking. Via a supply device the filled sacks also with the sliding device according to the invention are laterally conveyed to the sliding area for the establishment of the layer. As soon as the layer is performed this completed layer of filled sacks is slid to the sliding table with the help of a slider. Subsequently, the sliding table can open so that the completed layer can be lowered to a lifting device or an already completed and stacked layer underneath the lifting table. By the lifting device the configured sack stacking can in turn be moved downwards, so that the sliding table can reclose again. Subsequently, the process starts over.

With a sliding device according to the invention now the movement of the layer between the sliding area and the sliding table is improved. The sliding area is performed with a structural section which comprises a three dimensional surface structure. This three dimensional surface structure serves for the function of the reduction of the fiction during sliding. By a three dimensional surface structure is thereby a surface of the structural section to be understood which comprises a three dimensional form for example by elevations or depressions. Thus this surface structure can also be understood as elevating or depressing surface structure. In summary this leads to the fact that in comparison to an even contact area the sum of the contact areas between a filled sack which slides about the same and this three dimensional surface structure is clearly reduced. Is for example the three dimensional surface structure configured in form of elevations, the filled sacks will only contact the structural section in the area of the elevations and not in the depressions between the elevations. Thereby, the contact area is reduced wherein correspondingly also the resistance force by friction is reduced. If however the three dimensional surface structure is for example performed by depressions, a filled sack will especially not contact the structural section in the depression area during the sliding process. In a similar manner, here also the possibility of a reduction of the contact area results and thereby a reduction of the resistance force by friction.

Beneath a simple reduction of the contact area and the already along with that the reduction of the friction effect during the sliding process according to the invention also a static and thereby passive air cushion is produced. While with known solutions an active nature air is blown in, in order to ensure the floating on or to the filled sacks to the corresponding openings by the three dimensional surface structure according to the present invention so to say automatically a passive or a static air cushion is ensured. Due to the fact that the depression areas between the elevations of the three dimensional surface structure or the corresponding depressions have no contact to the filled sack during the sliding process, but rather an empty volume filled with air remains there, a sticking can be avoided particularly effective. Thereby so to say a static air cushion additional to the friction reduction by a reduction of the contact area can ensure a simplified sliding.

In summary the performance of the structural section according to the present embodiments leads to the fact that the sliding process can occur with less resistance. On the one hand this leads to a lower abrasion of the structural section itself and thereby the sliding area. Further, a lower force effort can come along with a smaller and thereby cost-efficient actuation device of the slider. Not at least the sliding device occurs also in a more careful manner, so that the surface of the filled sacks is stressed with less mechanical interfering during the sliding process. Also a local adhesion particularly during the breaks in the sliding process is effectively avoided by the described static or passive air cushions.

The structural section is thereby intended in the area in which the filled sacks perform a movement during the sliding process. It is preferred when the whole movement area via which the filled sacks slide during the sliding process from the sliding area to the sliding table are supplied with the corresponding structural section. Like it is subsequently described preferably also the sliding table can comprise corresponding structural sections. It is thereby also preferred when the structural section or the structural sections comprise a width which correlates with the maximum width of the to be performed layer of the filled sacks. With other words the sliding area can comprise a sliding section which corresponds to the sliding movement so that the sliding section is mainly completely performed as a structure section.

It can be an advantage when with the sliding device according to the present embodiments at least a structural section extends over the complete sliding width. Thereby it has to be understood that on a sliding area different sizes of layers can be performed. Concerning the translational movement direction during the sliding process and transverse to this direction the sliding width can be understood in a way that with a maximal width of the layer of filled sacks the sliding width is necessary in order to perform the sliding process. If now the structural section extends according to the invention over the whole sliding width so the whole sliding width can provide the corresponding reduction of the resistance. The advantages according to the invention reach its impacts thereby over the complete sliding width. It is also preferred when the structure section comprises the extension not only over the whole sliding width but also over the complete or mainly the complete sliding length in order to ensure the advantages of the present invention over the complete distance section of the sliding process.

Another advantage is achievable when with the sliding device according to the invention the sliding table comprises at least a structural section. Like already described at least a part of the sliding process also occurs for a part of the filled sacks of the layer on the sliding table. The sliding table itself comprises correspondingly preferably likewise a structural section. Naturally also this part of the sliding table can be performed as a sliding area so that also only a sliding table can comprise a corresponding structural section. The advantages of the performance of the structural section in the area of the sliding table are identical with the described advantages of the sliding area. It is preferred when in all sections which function as a contact area to the conveyed sacks during the sliding process a corresponding structural section is intended.

It is also an advantage when with the sliding device according to the invention the sliding area comprises at least a sliding belt wherein the at least one structural section is assembled neighbouring in sliding direction of the slider beneath the sliding belt. Since as known a supply normally occurs from one side, the filled sacks have to be moved from a feed position in a sliding position. Therefore, a sliding belt can be used in the sliding device which configures a part of the sliding area. Naturally, it is possible that also the sliding belt itself comprises a corresponding structural section or is configured as a structure sliding belt. However, it is important that with this embodiment of the present invention the at least one structural section is assembled neighboured, particularly directly neighboured, in sliding direction of the slider beneath the sliding belt. If now the sliding process starts the slider moves the filled sacks from the sliding belt to the neighbouring structure section. In this structure section now the effect of the reduced resistance according to the invention occurs so that the advantages according to the invention immediately show the effect for the sliding process. Naturally also two or more sliding belts can be intended when two or more supply belts should be used in the supply device. The transitions between the respective sliding belts and the structural sections can thereby naturally be smoothed so that particularly an overlap in this area avoids a gap formation.

Another advantage can be when with the sliding device according to the invention the at least one structural section comprises an elevation and/or depression particularly in a shaped manner. Like already described the elevations and/or depressions are preferred embodiments of the three dimensional surface structure. A shaped performance can particularly be provided by a cold forming. The shaped manner is thus a particularly simple and cost efficient production possibility for the structural section. Thereby the structural section can be performed separately or in one piece with the sliding area for example from a metal sheet.

Another advantage is achievable when with the sliding device according to the invention the at least one structural section comprises a variety of structural elements which comprise the same or mainly the same orientation. Thereby it is to be understood that so to say a guiding functionality is provided. The orientation occurs preferably along the sliding direction. Thus, the single structural elements can comprise a longitudinal form which overlaps with its main extension direction with the sliding direction. Also a transverse direction is possible in order to avoid a corresponding further reduction and moreover an undesired sliding of the filled sacks. The guidance functionality serves however particularly for the fact to avoid a lateral escape of the filled sacks so that subsequent to the performance of the respective layer on the sliding area the layer positions relative to one another for the single filled sacks are kept also with a higher probability. The particular shape position and therewith the particular elevation and/or the particular depression can thereby be understood as a respective structure element.

It is also an advantage when with the sliding device according to the invention the variety of structural elements are shifted to one another in sliding direction of the slider. With other words the single structure elements can be performed transverse to the sliding direction in rows wherein the subsequent rows comprise an offset in sliding direction. This leads to the fact that the single rows in sliding direction overlap with one another and thereby a sinking of the filled sacks during the sliding over the structure elements is particularly effectively avoided. The offset in sliding direction is thereby particularly performed in the area of approximately half of the longitudinal orientation of the structure element so that a mainly always equal contact between all structure elements and the respective filled sack remains while the sliding process is performed.

It can also be an advantage when with the sliding device according to the invention the variety of structure elements comprises different structure heights. Therewith a waviness can be performed which in defined sections provides a reduction or also a defined and desired increase of the resistance. Therewith so to say the sliding speed can be influenced in geometric and constructive manner. Particularly, however by the waviness an additional air cushion is performed which further reduces the friction force and therewith the resistance in a static manner between the single higher structural heights.

It is also an advantage when with the sliding device according to the invention the at least one structural section is performed as a separate structure plate of the sliding area. This leads to multiple advantages. Therefore a separate structure plate can be also performed separate from the sliding area and correspondingly can be produced in a cost efficient and simple manner. Likewise a structure plate can be used and moreover be exchanged in separate embodiments in the sliding area so that with recognizable wear during the working life an exchange of this wear component is possible. In the mounting likewise a reduction of the effort is recognizable since the geometric extensions of the sliding area are independently configurable from the structure plate.

It can be another advantage when with the sliding device according to the present embodiments between the sliding area and the sliding table a height offset exists which is overcome particularly stepwise by the at least one structural section. A height offset in sliding direction downwards leads to the fact so to say to stepwise support the sliding process.

Since in this manner additionally an overlap of the single steps becomes possible, gap formations between the single steps can be effectively avoided and thereby a danger of squeezing or crushing of the filled sacks can be nearly excluded. The overcome of the height offset occurs thereby particularly by the structural section which is preferably performed as a separate structure plate within this embodiment.

### BRIEF DESCRIPTION OF THE DRAWINGS

Further advantages, features and details of the invention result from the following description, in which with reference to the drawings embodiments of the invention are described in detail. Thereby, the features described in the claims and in the description can be each single or in every combination be essential for the invention. It is schematically shown:

FIG. 1 an embodiment of the sack stacking during the stacking,

FIG. 2 a top view of a palletizing device with a sliding device according to the invention,

FIG. 3 an embodiment of FIG. 2 in a further sliding condition,

FIG. 4 an embodiment of a structural section,

FIG. 5 another embodiment of a structural section,

FIG. 6 another embodiment of a structural section,

FIG. 7 another embodiment of a structural section and

FIG. 8 a lateral drawing of a sliding device.

### DESCRIPTION OF SPECIFIC EMBODIMENTS OF THE INVENTION

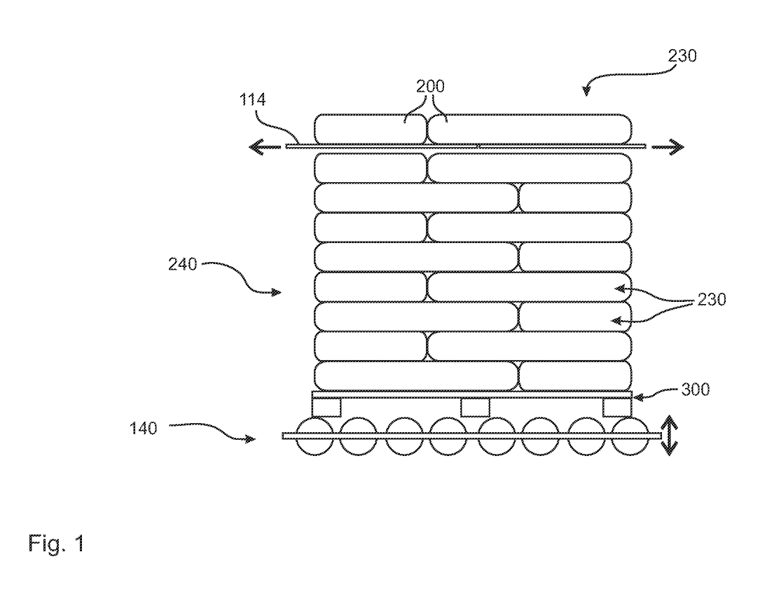

In FIG. 1 it is schematically shown how a stacking process of a sack stacking 240 can occur. Thus a pallet 300 can be assembled on a lifting device 140. On this pallet 300 already a variety of layers 230 is assembled which are part of the to be performed sack stacking 240. A further to be stacked layer 230 of the filled sacks 200 is still located above on the sliding table 114. The sliding table 114 is divided and can open towards the outside along both arrows so that the there assembled layer 230 of the filled sacks can sink and get in contact with the sack stacking 240. Subsequently, with the help of the lifting device 140 the whole sack stacking 240 is now sunk with the new uppermost layer 230 at least about a sack width so that the sliding table 114 can reclose. Subsequently the sliding table can take the next layer 230 of filled sacks.

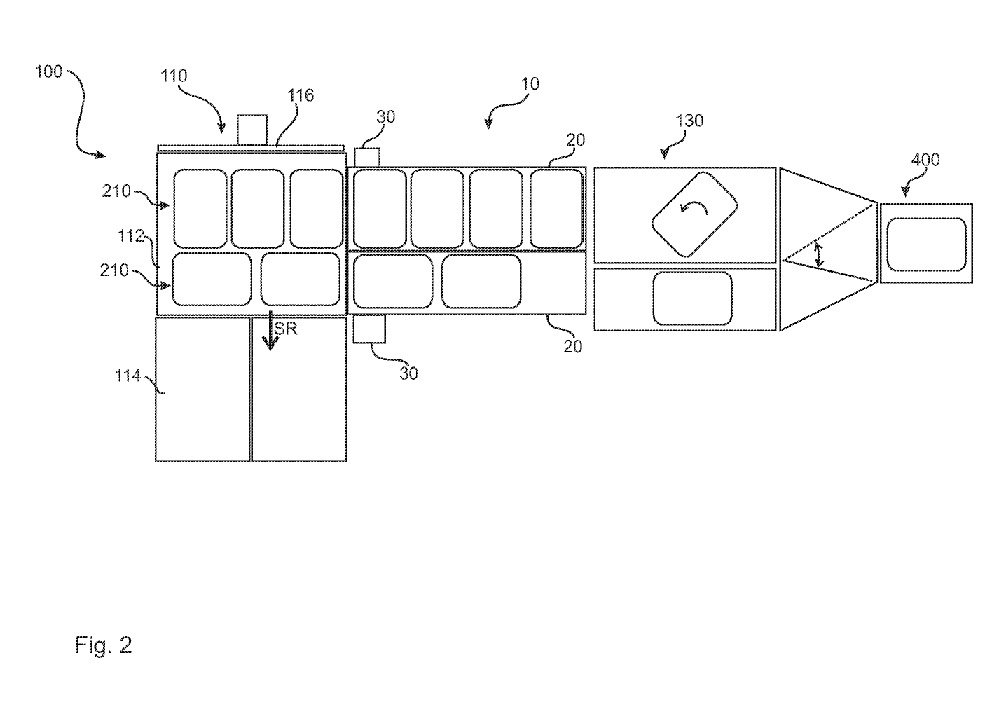

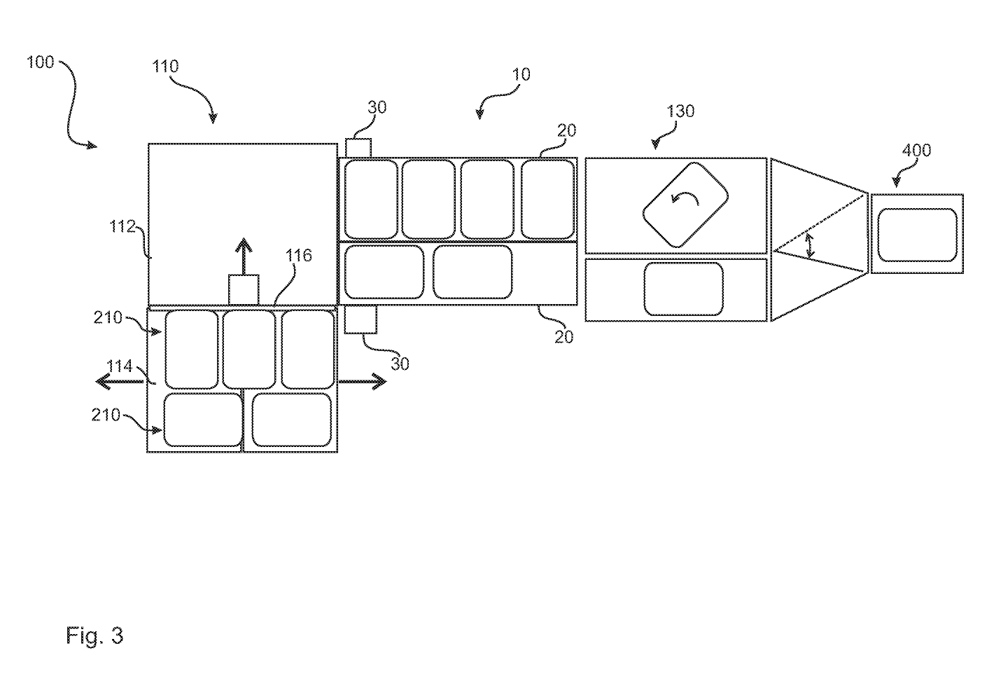

FIGS. 2 and 3 show the previous steps. Thus starting from the processing device 400 in the palletizing device 100 a variety of filled sacks can be provided. Thereby the production device can provide filled sacks 200 for example as a so called form-fill-and-seal machine. By a schematically shown switch an alteration of the rotation orientation of the filled sacks 200 can occur with the help of the rotation device 130. Therewith different overviews of different layer orientations of the layers 230 can be achieved. Outside or subsequent to the rotation device 130 a supply device 10 is intended with here two conveyance belts 20 with separate actuation devices 30. The supply occurs here in two rows 210 at the same time so that also the layer 230 is performed with two rows 210 of the filled sacks 200. The performance of the layer occurs thereby on the sliding area 112.

As soon as the layer 230 is configured on the sliding area 112 now the complete layer 116 can be slidden along the sliding direction SR from the sliding area 112 to the sliding table 114 with the help of a slider 116. The end of the sliding movement is shown in FIG. 3. From here now the stacking can occur by the opening of the sliding table 114 like already described in detail regarding FIG. 1.

For the sliding movement of the layer 230 like shown between FIG. 2 and FIG. 3 a movement of the filled sacks 200 has to occur. Thereby, the filled sacks 200 slide along the sliding area 112 and along the sliding table 114. According to the invention now at least in the area of the sliding area 112 a structural section 120 is intended. Naturally also the sliding table 114 can comprise one or multiple corresponding sliding sections 120. In the subsequent figures different embodiments of the structural sections 120 according to the invention are described in detail.

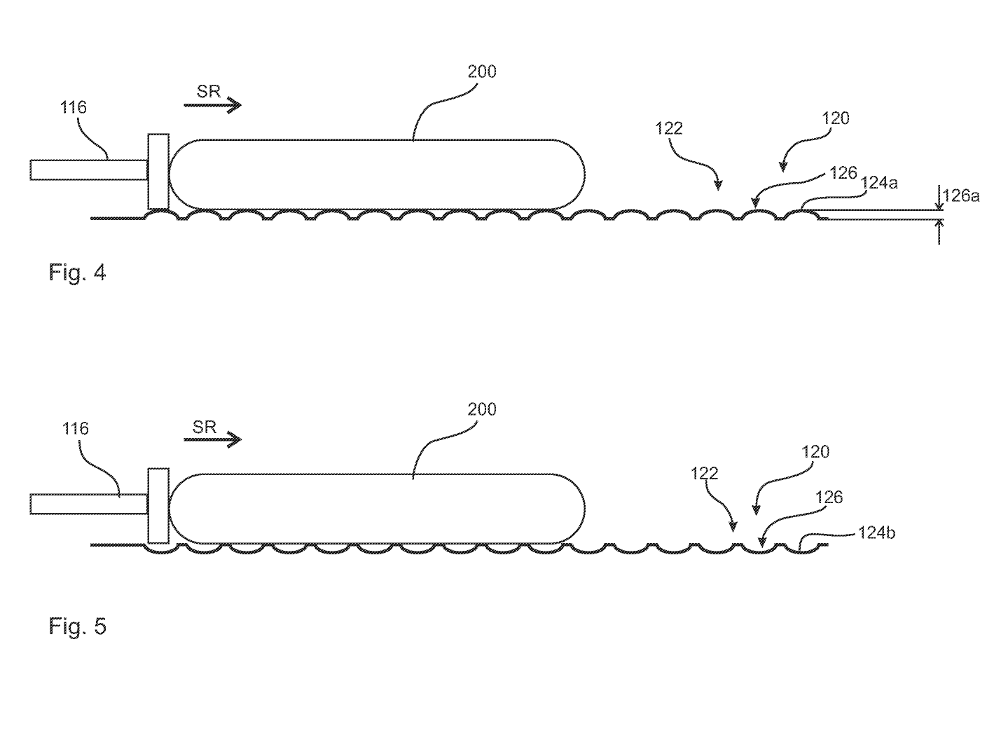

FIG. 4 shows a first possibility to perform a structural section 120. Here the single structure elements 126 are performed as elevations 124a which thereby result in a three dimensional surface structure 122 with a structure height 126a. With this embodiment the structure height 126a is constant. Like shown laterally now the filled sacks 200 can be moved to the right with the help of the slider 116 along the sliding direction SR. In contrast to a plane area now the actual contact area to the filled sacks 200 is reduced by the structure elements 126. Therewith also the resistance is reduced by the corresponding friction. Since moreover a static or passive air cushion between the structural section 120 namely the depression area and the filled sack 200 is performed, the sliding concerning the necessary sliding force is even more facilitated.

FIG. 5 shows in a schematic lateral drawing a similar embodiment to FIG. 4. However here the structural section 120 is performed with a surface structure 122 with a plurality of depressions 124b. Each of these depressions 124b performs thereby a single structure element 126. In the same manner like this was already described for FIG. 4 here however also the resistance is reduced by reduction of the contact area and by performance of the static or passive air cushions.

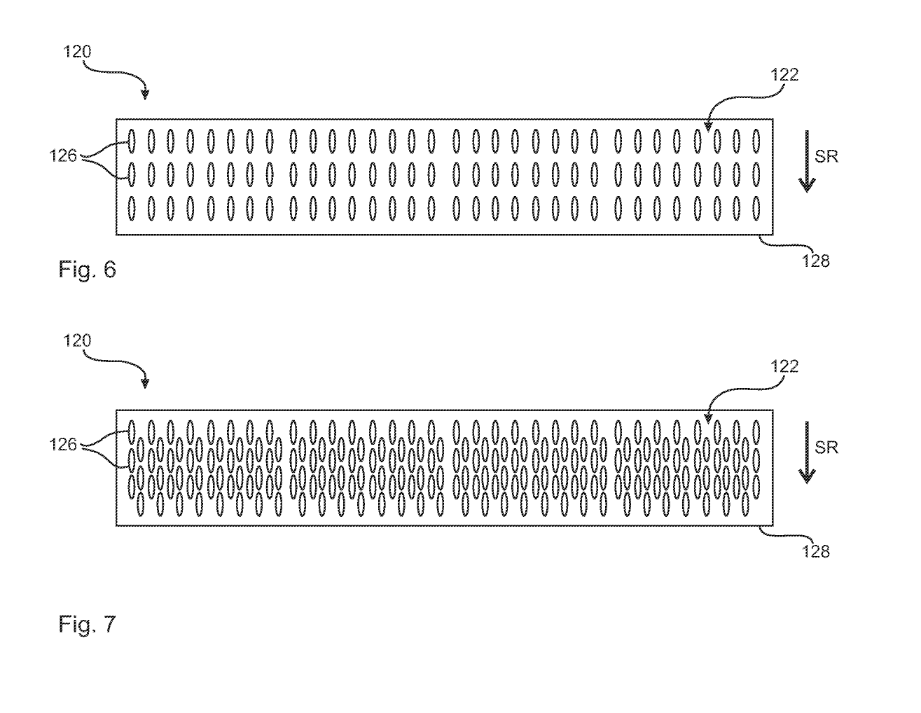

In FIG. 6 it is shown how in top view on a structural section 120 over the complete sliding width SB a corresponding performance of the structural section 120 can occur. Here the single structure elements 126 are performed row-like in order perform the corresponding three dimensional surface structure 122.

FIG. 7 shows a further development of FIG. 6 wherein the single rows of the structure elements 126 are shifted to one another in structure direction SR particularly are overlappingly performed and assembled. Therewith an undesired sinking of the filled sacks 200 is effectively avoided during the sliding process so that the advantages according to the invention are coming into complete effect.

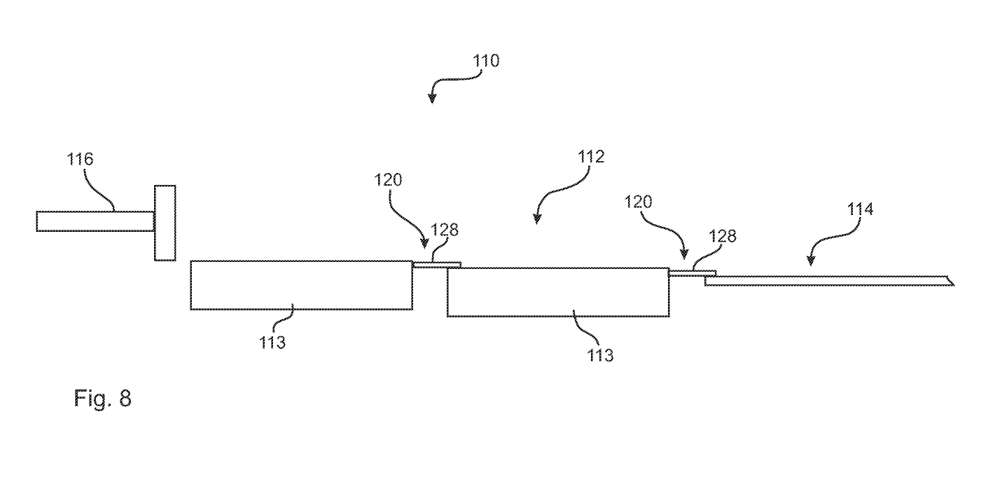

In FIG. 8 it is shown how a height offset during the sliding process can be compensated. So here in the area of the sliding area 112 two sliding belts 113 are intended in order to move the added filled sacks 200 each from a feed position in a sliding position. Between the conveyor belts 113 and neighbouring in direction of the sliding table 114 the structural sections 122 are performed as separate structure plates 128. The separate structure plates 128 are particularly performed interchangeable. With the height offset additionally a gap forming can be avoided by the shown overlap, so that the squeezing danger or crushing danger during the sliding process can be completely avoided.

The previous description of the embodiments describes the present invention only within the scope of examples. Naturally, also single features of the embodiments as far as technically meaningful can be freely combined with one another without leaving the scope of the present invention.

### REFERENCE LIST

10 supply device
20 conveyor belt
30 actuating device
100 palletizing device
110 sliding device
112 sliding area
113 sliding belt
114 sliding table
116 slider
120 structural section
122 surface structure
124a elevation
124b depression
126 structure element
126a structure height
128 structure plate
130 rotation device
140 lifting device
200 sack
210 row
230 layer
240 sack stacking
300 pallet
400 production device
SR sliding direction
SB sliding width

What is claimed is:

1. Sliding device for a palletizing device for stacking of filled sacks to a sack stacking, comprising a sliding area and a sliding table assembled beneath the sliding area and a slider for sliding of the sacks from a sliding area to the sliding table,
wherein
the sliding area comprises at least a structural section with a three dimensional surface structure for the reduction of the friction during the sliding of the sacks .

2. Sliding device according to claim 1,
wherein
at least a structural section extends over the complete sliding width.

3. Sliding device according to claim 1,
wherein
the sliding table comprises at least a structural section.

4. Sliding device according to claim 1,
wherein
the sliding area comprises at least a sliding belt wherein the at least one structural section is assembled neighbouring to the sliding belt in sliding direction of the slider.

5. Sliding device according to claim 1,
wherein
at least a structural section comprises at least one member of the group consisting of elevations and depressions.

6. Sliding device according to claim 1,
wherein
the at least one structural section comprises a variety of structure elements which comprise a mutually same orientation.

7. Sliding device according to claim 6,
wherein
the variety of structure elements are assembled in a shifted manner towards one another in sliding direction of the slider.

8. Sliding device (110) according to claim 6,
wherein
a variety of structure elements comprises different structure heights.

9. Sliding device according to claim 1,
wherein
the at least one structural section is configured as a separate structure plate of the sliding area.

10. Sliding device according to claim 1,
wherein
between the sliding area and the sliding table a height offset exists which is overcome by the at least one structural section.

11. Sliding device according to claim 10, wherein the structural section is a stepwise section.

12. Sliding device according to claim 1,
wherein
at least a structural section comprises at least one member of the group consisting of elevations and depressions, said member being a shaped member.
